(19) United States
(12) Patent Application Publication
(10) Pub. No.: US 2026/0167121 A1
(43) Pub. Date: Jun. 18, 2026

(54) SENSOR ARRANGEMENT, MOTOR VEHICLE, AND METHOD

(71) Applicant: AUMOVIO Autonomous Mobility Germany GmbH, Ingolstadt (DE)

(72) Inventors: Stefan Hegemann, Wangen im Allgäu (DE); Florian Geis, Geisenheim (DE)

(73) Assignee: AUMOVIO Autonomous Mobility Germany GmbH, Ingolstadt (DE)

(21) Appl. No.: 19/423,133

(22) Filed: Dec. 17, 2025

(30) Foreign Application Priority Data
Dec. 18, 2024 (DE) 10 2024 138 589.8

(51) Int. Cl. B60R 11/04; B60R 11/00

(52) U.S. Cl. CPC B60R 11/04; B60R 2011/004; B60R 2011/0087

(57) ABSTRACT

A sensor arrangement for a motor vehicle includes: a sensor support and a plurality of sensors which are fastened to the sensor support. The plurality of sensors include at least one of a camera, a radar, and a lidar; a fastening unit for fastening the sensor support to the motor vehicle; a joint which couples the sensor support and the fastening unit to one another. A relative orientation of the sensor support and of the fastening unit to one another is changeable in order to change a detection range of the plurality of sensors. A motor vehicle and a method are also specified.

### CROSS REFERENCE TO RELATED APPLICATIONS

This application claims priority to German Application No. 10 2024 138 589.8, filed Dec. 18, 2024, the contents of such application being incorporated by reference herein.

### FIELD OF THE INVENTION

A sensor arrangement for a motor vehicle is specified, in particular a so-called sensor POD. In addition, a motor vehicle is specified, in particular a motor vehicle which has a sensor arrangement as described herein. In addition, a method for operating a sensor arrangement is specified, in particular a method for operating a sensor arrangement described herein.

### BACKGROUND OF THE INVENTION

Motor vehicles, such as trucks, have sensors, for example, in order to enable autonomous driving.

It is desirable to specify a sensor arrangement for a motor vehicle that enables reliable operation. It is moreover desirable to specify a motor vehicle having such a sensor arrangement that enables reliable operation. It is moreover desirable to specify a method for operating a sensor arrangement that enables reliable operation.

### SUMMARY OF THE INVENTION

The disclosure relates to a sensor arrangement for a motor vehicle. The disclosure also relates to a motor vehicle, for example a truck and/or a bus. The disclosure additionally relates to a method for operating a sensor arrangement, in particular for operating a sensor arrangement described herein according to any one of the described exemplary embodiments.

According to one embodiment, the sensor arrangement has a sensor support. The sensor arrangement has a plurality of sensors. The sensors of the plurality of sensors are each fastened to the sensor support. The plurality of sensors has at least one of a camera, a radar, and a lidar. The sensors of the plurality of sensors are any combination of camera, radar, and lidar. For example, the plurality of sensors has at least one camera, at least one radar, and at least one lidar. Further sensor types are also possible, for example, ultrasonic sensors. The sensors of the plurality of sensors are configured and designed to ascertain information about the surroundings of the motor vehicle, for example, information that is used for autonomous driving of the motor vehicle. For this purpose, the sensors are connected for the transmission of signals, for example, to a vehicle controller of the motor vehicle. For example, the sensors are configured and designed to sensorially detect obstacles, lanes, other motor vehicles, people, animals, and/or other elements in the surroundings of the motor vehicle.

The sensor arrangement has a fastening unit for fastening the sensor support to the motor vehicle. For example, the fastening unit is connectible to the motor vehicle, in particular to a body of the motor vehicle, by means of screws, bolts, welding, clamps, or other types of fastening.

The sensor arrangement has a joint. The joint couples the sensor support and the fastening unit to one another. In particular, the sensor support and the fastening unit are fixed to one another by means of the joint. Here, the joint permits an intended relative movement between the sensor support and the fastening unit. It is also possible for the joint to be blocked in a specific operating state, such that the relative movement between the sensor support and the fastening unit is blocked.

A relative orientation of the sensor support and of the fastening unit to one another is changeable in order to change a detection range of the plurality of sensors. For example, when in the operationally ready state on the motor vehicle, the sensors are arranged in a first operating state such that they sensorially monitor a first detection range. In a second operating state, the orientation of the sensor support and of the fastening unit relative to one another is changed. The sensors are therefore arranged differently relative to the motor vehicle than in the first operating state. A different detection range can therefore be sensorially monitored by means of the sensors in the second operating state than in the first operating state. In this case, the fastening unit is fixable rigidly to the motor vehicle. The change in the detection range is possible due to the joint. The joint allows a moving of the sensor support in order to change the detection range.

For example, it is therefore possible to adapt the detection range to an area around the motor vehicle that is desired in a specific operating state of the motor vehicle and/or is required by law. It is also possible to adapt the detection range to other sensors of the motor vehicle. If, for example, other sensors do not function as desired and provide the corresponding desired data, it is possible to adapt the detection range of the sensor arrangement in such a way that these missing data can be provided by means of the sensor arrangement.

According to one embodiment, the joint has a tilt joint for tilting the sensor support relative to the fastening unit around a first axis of the sensor support. The first axis is, for example, parallel or virtually parallel to a longitudinal axis of the motor vehicle in the installed state of the sensor arrangement. For example, starting from the fastening unit, the sensor arrangement extends longer along a second axis than along the first axis. For example, the joint is arranged between the sensor support and the fastening unit along the second axis. The first axis is, for example, oriented in the same direction as a straight main direction of travel of the motor vehicle. The tilting of the sensor support around the first axis thus permits upward and downward tilting of the sensor support.

Alternatively or additionally, the joint has a pivot joint for a rotation of the sensor support relative to the fastening unit around the second axis of the sensor support. The sensor support is, for example, pivotable around the second axis in order to change the detection range.

Any desired combination of different joints is possible, or a single joint that permits a relative movement in a wide variety of directions. It is thus possible, for example, for the sensor support to be able to be both tilted and rotated relative to the fastening unit. For example, a ball joint is provided for this purpose.

According to one embodiment, the joint is designed for an incremental change of the relative orientation. Alternatively or additionally, the joint is designed for a continuous change of the relative orientation. For example, the joint has a plurality of discrete, predefined positions of the sensor support and of the fastening unit relative to one another. A continuous change enables, for example, a continuous, slow relative movement of the sensor support relative to the fastening unit, so that scanning of different detection ranges in operation is made possible.

According to one exemplary embodiment, the motor vehicle is designed for assisted and/or automated driving. In particular, the motor vehicle is a so-called autonomous motor vehicle. The motor vehicle has a sensor arrangement according to any one of the embodiments described here. The fastening unit of the sensor arrangement is fastened to the body of the motor vehicle, and therefore an orientation of the sensor support relative to the body is changeable. It is therefore possible during the operation of the motor vehicle, for example, during the journey, to change and adapt the detection range of the sensor arrangement relative to the vehicle. It is thus, for example, possible to sensorially monitor different areas around the vehicle by means of the sensor arrangement. Therefore, for example, by means of the sensor arrangement, monitoring is possible both in one detection range for faster driving operation and in another detection range for slow driving operation. In addition, it is possible to provide redundancy for other sensors of the motor vehicle.

According to one embodiment, the motor vehicle has a further sensor arrangement. The further sensor arrangement and the sensor arrangement can be constructed similarly and thus have similar sensors. It is also possible that the sensor arrangement and the further sensor arrangement have different sensors. In particular, the sensor arrangement and the further sensor arrangement are each designed to be arranged laterally on the motor vehicle. The sensor arrangement is arranged, for example, on a first vehicle longitudinal side. The further sensor arrangement is arranged, for example, on an opposite second vehicle longitudinal side. The sensor arrangement and the further sensor arrangement are therefore arranged in order to monitor a detection range laterally adjacent to the motor vehicle and behind the motor vehicle.

According to one embodiment, the sensor arrangement has, in a first operating mode, a first orientation of the sensor support for a first detection range at long range. In a second operating mode, the sensor arrangement has a second orientation of the sensor support for a second detection range at close range. The close range is arranged closer to the motor vehicle than the long range. The second operating mode is used, for example, when the motor vehicle is in a slow driving mode, for example, when maneuvering. The first operating mode is used, for example, in a faster driving mode, for example, on a freeway. It is possible for the detection range at close range to also be monitored by other sensors of the motor vehicle. If these sensors fail and/or do not provide reliable data, it is possible to use the sensor arrangement and/or the further sensor arrangement which is actually used for the long range for the close range in order to replace the failed sensor system.

The sensor arrangement is fastened to a motor vehicle. The method comprises changing an orientation of the sensor support relative to a body of the motor vehicle. As a result, a detection range of the plurality of sensors of the sensor arrangement is changed. For example, the orientation is changed depending on an operating mode of the motor vehicle. For example, it is possible to move the orientation back and forth between a plurality of predefined orientations. It is therefore possible to adapt the detection range to the present operating mode of the motor vehicle.

According to one embodiment, the method comprises ascertaining a failure of a near-field sensor of the motor vehicle. The orientation of the sensor support is changed in response to the determined failure, such that the detection range of the plurality of sensors is at close range to the motor vehicle. It is thus possible to monitor a detection range by means of the sensor device that would otherwise be monitored by the failed near-field sensor.

The sensor arrangement, the motor vehicle, and the method enable flexible use of the sensors. It is therefore possible, for example, to dispense with sensors which conventionally have to be provided on the motor vehicle. Alternatively or additionally, it is possible to enable redundancy of the sensors. Advantages and features of the sensor arrangement also apply to the motor vehicle and the method, and vice versa.

### BRIEF DESCRIPTION OF THE DRAWINGS

Further advantages, features, and refinements result from the following examples, which will be explained in connection with the figures. Identical, similar, or identically-acting elements may be provided here with the same reference numerals.

In the figures:

FIGS. 1 and 2 each show a schematic representation of a motor vehicle having two sensor arrangements according to one exemplary embodiment,

FIGS. 3 and 4 each show a schematic representation of a motor vehicle having a sensor arrangement according to one exemplary embodiment,

FIG. 5 shows a schematic representation of a sensor arrangement according to one exemplary embodiment, and

FIG. 6 shows a flow chart of a method according to one exemplary embodiment.

### DETAILED DESCRIPTION OF EXEMPLARY EMBODIMENTS

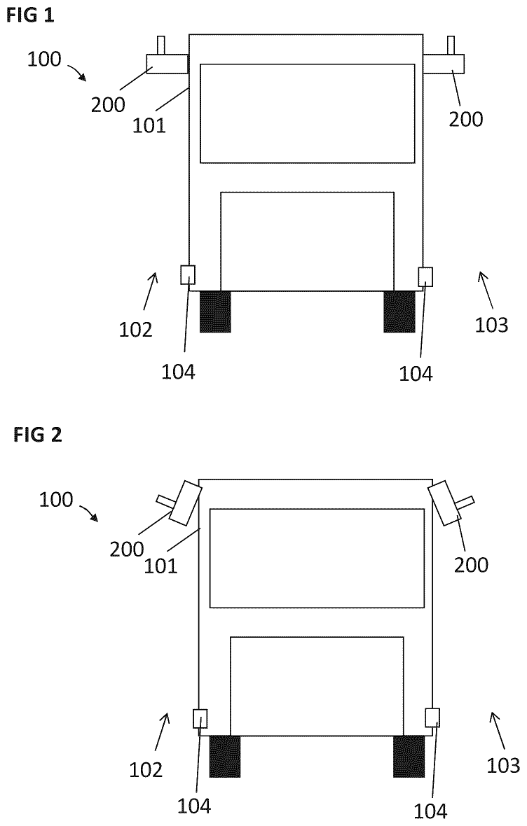

FIGS. 1 and 2 show a motor vehicle 100 having two sensor arrangements 200 according to one exemplary embodiment. The sensor arrangements 200 are, for example, each formed as also explained below in conjunction with FIG. 5.

The motor vehicle 100 is, for example, a truck or a bus. It is also possible for the motor vehicle 100 to be a passenger vehicle. The motor vehicle 100 has a main direction of travel. A front side of the motor vehicle 100 is directed in the direction of the main direction of travel. The motor vehicle 100 has a first vehicle side 102 and second vehicle side 103, which in particular extend along the main direction of travel and are arranged opposite to one another. The first vehicle side 102 and the second vehicle side 103 can each also be referred to as vehicle longitudinal sides. The first vehicle side 102 and the second vehicle side 103 extend in particular along a vehicle longitudinal direction.

The motor vehicle 100 has a body 101. The body 101 can also be referred to as a supporting chassis. One of the sensor arrangements 200 is coupled to the body 101, in particular fastened thereon, on the first vehicle side 102. The second sensor arrangement 200 is coupled to the body 101, in particular fastened thereon, on the second vehicle longitudinal side 103.

The motor vehicle 100 has further sensors, in particular, for example, a near-field sensor 104 or a plurality of near-field sensors 104, which are formed separately from the sensor arrangements 200. It is also possible to dispense with the near-field sensors 104.

The sensor arrangements 200 are in particular designed similarly and corresponding to one another. Therefore, primarily one of the sensor arrangements 200 will be discussed below, wherein what is described also applies to the other of the sensor arrangements 200.

The sensor arrangement 200 is in particular a so-called sensor POD, which has a plurality of sensors 210, 220, 230, as shown in FIG. 5. The sensor 210 is a camera, for example. The sensor 220 is a radar, for example. The sensor 230 is a lidar, for example. Other types of sensors and any combinations of these sensors 210, 220, 230 are possible. It is also possible for more than three sensors 210, 220, 230 or fewer than three sensors 210, 220, 230 to be provided.

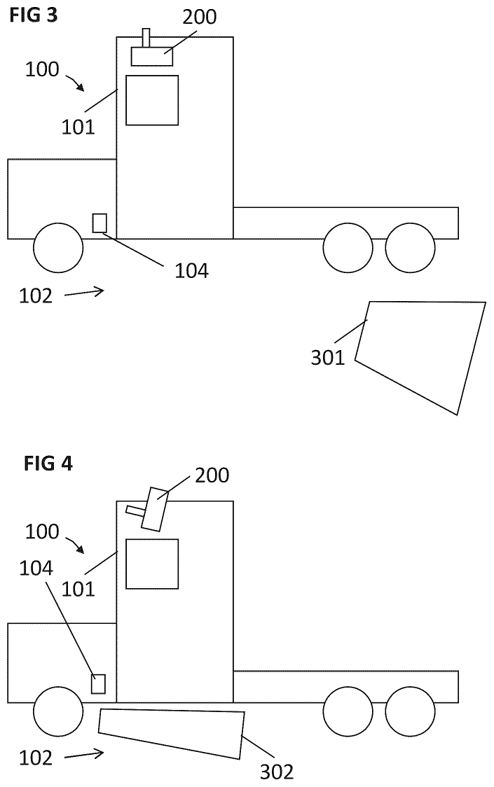

The sensor arrangement 200 is designed to monitor a detection range 301, 302 (FIGS. 3 and 4). The information provided by the sensor arrangement 200 about the detection range 301, 302 is used, for example, by a controller of the motor vehicle 100, which in particular has a processor and memory units, for assisted and/or automated driving operation of the motor vehicle 100. The motor vehicle 100 is thus, for example, an autonomously driving truck. For example, the motor vehicle 100 corresponds to a level 4 vehicle or a higher level according to SAE J3016. Even levels lower than level 4 vehicles are possible for the motor vehicle 100.

One of the sensor arrangements 200 is thus provided to monitor a detection range 301, 302 at the first vehicle side 102. The other of the sensor arrangements 200 is thus provided to monitor a detection range 301, 302 at the second vehicle side 103.

As can be seen from the difference between FIGS. 1 and 2 and FIGS. 3 and 4, it is possible to change the relative orientation of the sensor arrangement 200 or at least of the sensors 210, 220, 230 relative to the body 101. For example, it is possible to tilt the sensors 210, 220, 230 around a first axis 204 (FIG. 5). The first axis 204 extends in particular in the same direction as the main direction of travel of the motor vehicle 100 and, for example, in the same direction as the longitudinal extension of the vehicle sides 102, 103. For example, an electric motor (not explicitly illustrated) is provided, which drives the change in orientation.

Alternatively or additionally, it is possible to move the sensors 210, 220, 230 around axes oriented differently, for example, around a second axis 205, as is illustrated schematically in FIGS. 3 and 4. The second axis 205 (FIG. 5) is oriented, for example, perpendicularly to the first axis 204. It is also possible for the sensors 210, 220, 230 to be pivoted only around a single axis 204, 205, wherein this single axis 204, 205 can be oriented arbitrarily with respect to the motor vehicle 100. It is also possible to arrange the sensors 210, 220, 230 so they are pivotable arbitrarily relative to the body 101, for example, by means of a pivot joint.

In a first operating mode (FIGS. 1 and 3), which corresponds, for example, to a main operating mode of the sensor arrangement 200, the sensor arrangement 200 is provided and configured to determine and make available information about the detection range 301 at a long range. In a second operating mode (FIGS. 2 and 4), the sensor device 202 is provided and configured to determine and provide information about a second detection range 302 at a close range. In particular, the detection range 301 at long range is farther away from the motor vehicle 101 than the detection range 302 at close range. For example, the detection range 301 is arranged farther to the rear than the second detection range 302 with respect to an operationally ready orientation of the motor vehicle 100. It is also possible to orient the two different detection ranges 301, 302 differently relative to one another, for example, once next to the motor vehicle 100 and once in front of the motor vehicle 100, or laterally to the motor vehicle 100, once closer and once farther away from the motor vehicle 100.

The sensors 210, 220, 230 are oriented differently relative to the vehicle body 101 in the first operating mode than in the second operating mode. As a result, it is possible to monitor the different detection ranges 301, 302 in the different operating modes using the sensors 210, 220, 230.

For example, the sensor arrangement 200 is in the first operating mode, which is usually present, for the detection range 301 at a greater distance at long range. The second operating mode of the sensor arrangement 200 is predefined, for example, depending on an operating mode of the motor vehicle 100. If the motor vehicle 100 is maneuvering slowly, for example, the second operating mode of the sensor arrangement 200 according to FIG. 2 or 4 is used in order to provide better coverage of the immediate surroundings of the motor vehicle 100 in the closer detection range 302. This better coverage of the closer detection range 302 is possible using the same sensor arrangement 200 that is also used for the more distant detection range 301. Therefore, additional further sensors are avoided.

It is also possible to alternatively or additionally use the second operating mode of the sensor arrangement if other sensors, for example, the near-field sensors 104, fail. The sensor arrangement 200 is then used in the second operating mode to provide information that is otherwise provided by means of the near-field sensor 104.

It is also possible for the sensor arrangement 200 to be moved back and forth continuously between the two operating modes, for example, by means of a slow rotation. It is therefore possible, for example, to monitor both the detection range 301 at long range and the detection range 302 at close range.

As illustrated in FIG. 5, the sensor arrangement 200 has a sensor support 201. The sensor arrangement 200 has the fastening unit 203, by means of which the sensor arrangement 200 is fastenable to the body 101. A joint 202 is provided between the sensor support 201 and the fastening unit 203.

The joint 202 is, for example, a pivot joint and/or a ball joint. The joint 202 enables a relative movement between the sensor support 201 and the fastening unit 203 around the first axis 204 and/or around the second axis 205 and/or around further axes.

The sensors 210, 220, 230 of the sensor arrangement 200 are fastened in particular to the sensor support 201. In particular, the position of the respective sensors 210, 220, 230 on the sensor support 201 is predefined for the use in the sensor arrangement 200, in which the sensor support 201 is oriented differently relative to the body 101 in the various operating modes of the sensor arrangement 202. For example, the arrangement of the sensors 210, 220, 230 on the sensor support 201 is different from the arrangement in a conventional sensor POD, in which the sensors are arranged in a rigid and immovable manner relative to the body 101.

For example, the electric motor (not explicitly illustrated) is provided in order to change the relative orientation between the sensor support 201 and the fastening unit 203. The electric motor is arranged, for example, in order to pivot the sensor support 201 relative to the fastening unit 203.

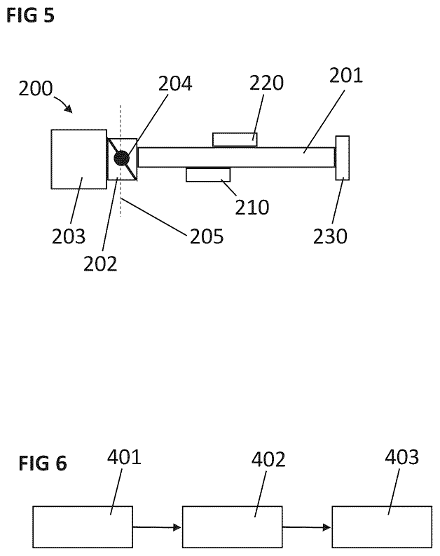

FIG. 6 shows a flow chart of a method for operating the sensor arrangement 200 according to one exemplary embodiment.

In a step 401, a desired operating mode for the sensor arrangement 200 is determined. For example, the desired operating mode is determined depending on an operating mode of the motor vehicle 100. Alternatively or additionally, the desired operating mode is determined, for example, depending on a functionality of a sensor system of the motor vehicle 100, for example, depending on a functionality of the near-field sensors 104.

In a step 402, the orientation of the sensors 210, 220, 230 relative to the body 101 is changed, for example, by changing the orientation of the sensor support 301 relative to the body 101. In particular, the orientation is changed depending on the desired operating mode determined in step 401.

In a step 403, which may take place at the same time as step 402, the detection range of the sensors 210, 220, 230 is changed. In particular, the detection range is changed depending on the change of the orientation. The detection range is changed in step 403 such that the operating mode determined in step 401 is enabled.

For example, it is determined in step 401 that the near-field sensor 104 of the motor vehicle has failed. Alternatively or additionally, slow maneuvering of the motor vehicle 100 is determined, in which information about the close range is necessary, which is conventionally provided by means of the near-field sensor 101. In order to provide this information despite the failure of the near-field sensor 104, the orientation of the sensors 210, 220, 230, which by default are directed, for example, onto the detection range 301 at long range, is changed such that they are directed onto the detection range 302 at close range.

It is also possible for the sensor arrangement 200 to be arranged, alternatively or additionally, not on one of the vehicle sides 102, 103 but rather at the front, for example, centrally above the windshield.

The sensor arrangement 200 according to the different examples enables variable adaptation of the detection range 301, 302. The sensor arrangement 200 is thus usable for a wide variety of operating modes of the motor vehicle 100; in particular, it is possible to also use the long-range sensor system for close-range maneuvers such as slow maneuvering. It is therefore possible, for example, to save sensors on the motor vehicle 100, and therefore a cost saving is also possible.

### LIST OF REFERENCE NUMERALS

100 motor vehicle
101 body
102 first vehicle side
103 second vehicle side
104 near-field sensor
200 sensor arrangement
201 sensor support
202 joint
203 fastening unit
204 first axis
205 second axis
210, 220, 230 sensor
301 detection range, long range
302 detection range, close range
401, 402, 403 method steps

1. A sensor arrangement for a motor vehicle, wherein the sensor arrangement has:
a sensor support,
a plurality of sensors which are fastened to the sensor support, wherein the plurality of sensors comprise at least one of a camera a radar, and a lidar,
a fastening unit for fastening the sensor support to the motor vehicle and
a joint which couples the sensor support and the fastening unit to one another, wherein a relative orientation of the sensor support and of the fastening unit to one another is changeable in order to change a detection range of the plurality of sensors

2. The sensor arrangement as claimed in claim 1, in which the joint has a tilt joint for tilting the sensor support relative to the fastening unit around a first axis of the sensor support.

3. The sensor arrangement as claimed in claim 1, in which the joint has a pivot joint for rotating the sensor support relative to the fastening unit around a first axis of the sensor support.

4. The sensor arrangement as claimed in claim 1, in which the joint is designed for an incremental change in relative orientation.

5. The sensor arrangement as claimed in claim 1, in which the joint is designed for a continuous change in relative orientation.

6. A motor vehicle having:
a sensor arrangement as claimed in claim 1, wherein the fastening unit is fastened to a body of the motor vehicle so that an orientation of the sensor support relative to the body is changeable.

7. The motor vehicle as claimed in claim 6, having a further sensor arrangement for a motor vehicle,
wherein the sensor arrangement has:
a sensor support,
a plurality of sensors which are fastened to the sensor support, wherein the plurality of sensors comprise at least one of a camera, a radar, and a lidar,
a fastening unit for fastening the sensor support to the motor vehicle, and
a joint which couples the sensor support and the fastening unit to one another, wherein a relative orientation of the sensor support and of the fastening unit to one another is changeable in order to change a detection range of the plurality of sensors, wherein the sensor arrangement arranged on a first vehicle longitudinal side and the further sensor arrangement is arranged on an opposite second vehicle longitudinal side.

8. The motor vehicle as claimed in claim 6, wherein the sensor arrangement has a first orientation of the sensor support for a first detection range at long range in a first operating mode and has a second orientation of the sensor support for a second detection range at close range in a second operating mode, wherein the close range is arranged closer to the motor vehicle than the long range.

9. A method for operating a sensor arrangement as claimed in claim 1, which is fastened to a motor vehicle the method comprising:
changing an orientation of the sensor support relative to a body of the motor vehicle, and as a result
changing a detection range of the plurality of sensors.

10. The method as claimed in claim 9, comprising:
determining a failure of a near-field sensor of the motor vehicle,
changing the orientation in response to the determined failure with respect to a detection range of the plurality of sensors at close range to the motor vehicle.
